(19) United States
(12) Patent Application Publication
(10) Pub. No.: US 2023/0342214 A1
(43) Pub. Date: Oct. 26, 2023

(54) METHODS AND APPARATUS FOR A REMOTE PROCESSING ACCELERATION ENGINE

(71) Applicant: Intel Corporation, Santa Clara, CA (US)

(72) Inventors: Thomas E. Willis, Redwood City, CA (US); Vered Bar Bracha, Somerville, MA (US); Dinesh Kumar, Portland, OR (US); David Anderson, Hillsboro, OR (US); Dror Bohrer, Kiryat Tiv'on (IL); Stephen Ibanez, Escondido, CA (US); Salma Johnson, Littleton, MA (US); Brad Burres, Waltham, MA (US)

(21) Appl. No.: 18/345,497

(22) Filed: Jun. 30, 2023

(51) Int. Cl. G06F 9/50; G06F 9/54

(52) U.S. Cl. CPC G06F 9/505; G06F 9/547

(57) ABSTRACT

Systems, apparatus, articles of manufacture, and methods are disclosed for a remote processing acceleration engine. Disclosed is an infrastructure processing unit (IPU) comprising an offload engine driver to access a remote procedure call (RPC) from business logic circuitry, network interface circuitry, and RPC offload circuitry to select a destination to perform an operation associated with the RPC call, the destination selected based on an ability of the destination to perform the operation using remote direct memory access (RDMA), and cause communication of the operation to the destination via the network interface circuitry.

### FIELD OF THE DISCLOSURE

This disclosure relates generally to remote procedure call protocols and, more particularly, to methods and apparatus for a remote processing acceleration engine.

### BACKGROUND

Remote Procedure Call (RPC) protocols such as gRPC are core building blocks to support microservices in cloud-based environments. RPCs are used to implement client-to-server communications designed specifically for the support of network applications. RPCs are used to identify servers capable of performing tasks initiated by a client.

### BRIEF DESCRIPTION OF THE DRAWINGS

FIG. 1 is a block diagram of an example offload environment in which an example client device and an example server operates to accelerate an operation.

FIG. 2 is a block diagram of an example implementation of the client device of FIG. 1.

FIG. 3 is a block diagram of an example implementation of the server of FIG. 1.

FIG. 4 is a flowchart representative of example machine readable instructions and/or example operations that may be executed, instantiated, and/or performed by example programmable circuitry to implement the example offload environment of FIG. 1.

FIG. 5 is a flowchart representative of example machine readable instructions and/or example operations that may be executed, instantiated, and/or performed by example programmable circuitry to implement the example client offload engine of FIG. 2.

FIG. 6 is a flowchart representative of example machine readable instructions and/or example operations that may be executed, instantiated, and/or performed by example programmable circuitry to implement the example server offload engine of FIG. 3.

FIG. 7 is a flowchart representative of example machine readable instructions and/or example operations that may be executed, instantiated, and/or performed by example programmable circuitry to implement example load sharing analyzer circuitry of FIG. 2.

FIG. 8 is a flowchart representative of example machine readable instructions and/or example operations that may be executed, instantiated, and/or performed by example programmable circuitry to implement example client offload engine communication circuitry and/or example server offload engine communication circuitry of FIGS. 2 and/or 3.

FIGS. 9-10 are block diagrams of example processing platforms including programmable circuitry structured to execute, instantiate, and/or perform the example machine readable instructions and/or perform the example operations of FIGS. 4-6 to implement the example client and the example server of FIGS. 1-3.

FIG. 11 is a block diagram of an example implementation of the programmable circuitry of FIGS. 9-10.

FIG. 12 is a block diagram of another example implementation of the programmable circuitry of FIGS. 9-10.

FIG. 13 is a block diagram of an example software/firmware/instructions distribution platform (e.g., one or more servers) to distribute software, instructions, and/or firmware (e.g., corresponding to the example machine readable instructions of FIGS. 4-8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

Remote Procedure Call (RPC) protocols such as gRPC are core building blocks to support microservices in the cloud. With existing Hypertext Transfer Protocol (HTTP) & Transmission Control Protocol (TCP) based software implementations, these protocols can suffer from large average latencies as well as broad (spread out) latency distributions.

Existing solutions are primarily software-focused and do not leverage domain-specific hardware in a system component such as an Infrastructure Processor (IPU) to support RPC operations. Software-focused solutions suffer from longer average latencies as well as a wider latency distribution. Further, common TCP-based implementations inherit many of the limitations of TCP and require additional layers of protocol support (for features such as reliability) adding further latency and further deviation between average and maximum latency (also known as tail latency) due to higher network congestion associated with cloud native distributed processing (also known as micro-services). In some examples, the IPU may alternatively be implemented using a Data Processing Unit (DPU), a smart Network Interface Card (smartNIC), a host bus adapter (HBA), or any other suitable form of programmable processor and/or system-on-chip (SoC). The IPU may include chiplets, dielets, tiles, a multi-chip package, or any other configuration of chip/SoC architecture.

Examples disclosed herein couple a hardware engine designed to support RPC with a transport like remote direct memory access (RDMA) that can provide better efficiency (e.g., lower latency) than existing implementations. The engine allows decisions to be made closer to the network that can enable more efficient use of the network. Such decisions being made close to the network leads to better performance and works with efficient transports such as RDMA. Examples disclosed herein also allow for decoupling interface-related decision such as workload distribution and load balancing between available worker nodes (also known as servers or end-points), from application (also known as business logic).

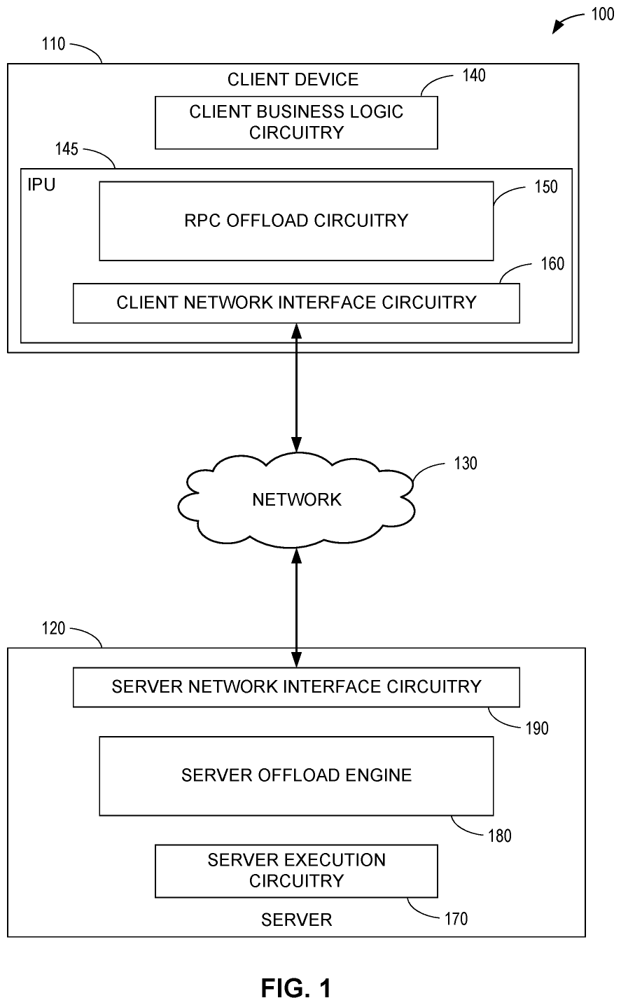

FIG. 1 is a block diagram of an example offload environment 100 in which an example client device 110 and an example server 120 operate to perform an RPC operation. The example illustration of FIG. 1 shows the client device 110 able to communicate with the server 120 via a network 130. In some examples, the network 130 is any one of or combination of a public network, a Virtual Private Network (VPN), a private network, or any other similar communication platform to enable two or more computing devices to communicate. In some examples, the client device 110 also includes a server, and the communication from the client device 110 to the server 120 is consistent with a data center architecture, including performing micro services within the data center. In such an example, the communication is a server-to-server communication within a data center for performing operations such as cloud-based management and/or managing neural networks. In some examples, the communication between the client device 110 and the server 120 is a management and orchestration (MANO) implementation. Such an implementation can be used to manage and orchestrate operations to be performed by the client device 110 and the server 120.

The example client device 110 includes client business logic circuitry 140, an IPU 145 (or a DPU, smartNIC, HBA, etc.), RPC offload circuitry 150, and client network interface circuitry 160. In some examples, the client business logic circuitry 140 is a customer-facing application that contains logic specific to the customer (e.g., application software/package). The client business logic circuitry 140 communicates with the RPC offload circuitry 150.

The IPU 145 can contain the RPC offload circuitry 150 and the client network interface circuitry 160. In some examples, the IPU 145 accesses a remote procedure call (RPC) from the client business logic circuitry 140 for determining a destination to send an operation to (e.g., selecting a server to execute/perform the operation).

The RPC offload circuitry 150 communicates with the client business logic circuitry 140 and the client network interface circuitry 160. In some examples, the RPC offload circuitry 150 retrieves an operation (e.g., a question asked of a user, a command issued by client business logic circuitry 140, a request to send/read/write to/from the server 120, etc.) and determines which server (e.g., the server 120) to send the operation to for execution/performance. In some examples, a Kubernetes implementation is used to perform/deploy the operation to/from the server 120. As used herein, an operation can include a remote operation or any other kind of request that the client device 110 may request of the server 120 to perform.

The client network interface circuitry 160 interfaces with the network 130 to send and retrieve information across the network 130. In some examples, the client device 110 communicates with the network 130, and thus the server 120, via the client network interface circuitry 160. The client network interface circuitry 160 can be any kind of network interface such as an Ethernet interface (e.g., wired to the network 130), a wireless interface (e.g., Wi-Fi), a cellular interface, InfiniBand, etc.

The example server 120 includes server execution circuitry 170, a server offload engine 180, and server network interface circuitry 190. In examples disclosed herein, the server network interface circuitry 190 on the server 120 operates in the same way as the client network interface circuitry 160 on the client device 110 (e.g., interfacing with the network 130 for sending and retrieving information). Similarly, the server network interface circuitry 190 can be any kind of network interface such as an Ethernet interface (e.g., wired to the network 130), a wireless interface (e.g., Wi-Fi), a cellular interface, InfiniBand, etc.

The server execution circuitry 170 enables execution/performance of operations. In some examples, the server execution circuitry 170 includes machine learning models/neural networks, instructions for executing repeated operations, etc. As disclosed in further detail herein, the server execution circuitry 170 is used for executing operations in on the server 120 that are non-accelerated.

The server offload engine 180 includes server-specific software and hardware for executing operations. In some examples, the server offload engine 180 includes acceleration hardware such as IPUs or other query-specific hardware designs for executing operations. In some examples, the server offload engine 180 uses a combination of executing operations in software and in hardware (e.g., executing software on server-specific hardware and/or dedicated acceleration hardware within the server 120). In some examples, the server offload engine 180 utilizes remote direct memory access (RDMA) to execute/perform the operation to reduce latency. In some examples, RDMA over Converged Ethernet (RoCE) is used to leverage communication protocols between compute devices using an Ethernet connection while still maintaining the low latency functionality of RDMA.

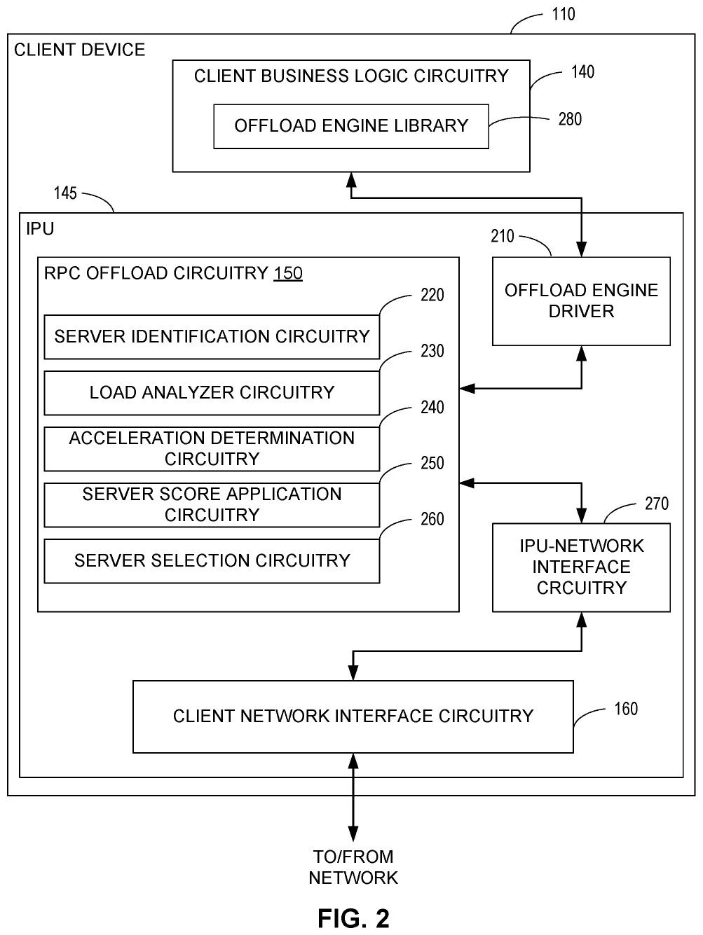

FIG. 2 is a block diagram of an example implementation of the example client device 110 of FIG. 1 to offload/accelerate the operation on the appropriate server (e.g., the server 120). The client device 110 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the client device 110 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example client device 110 includes the client business logic circuitry 140, the IPU 145, the RPC offload circuitry 150, and the client network interface circuitry 160. The IPU 145 includes the RPC offload circuitry 150, the client network interface circuitry 160, an offload engine driver 210, and IPU-network interface circuitry 270. The RPC offload circuitry 150 includes server identification circuitry 220, load analyzer circuitry 230, acceleration determination circuitry 240, server score application circuitry 250, and server selection circuitry 260.

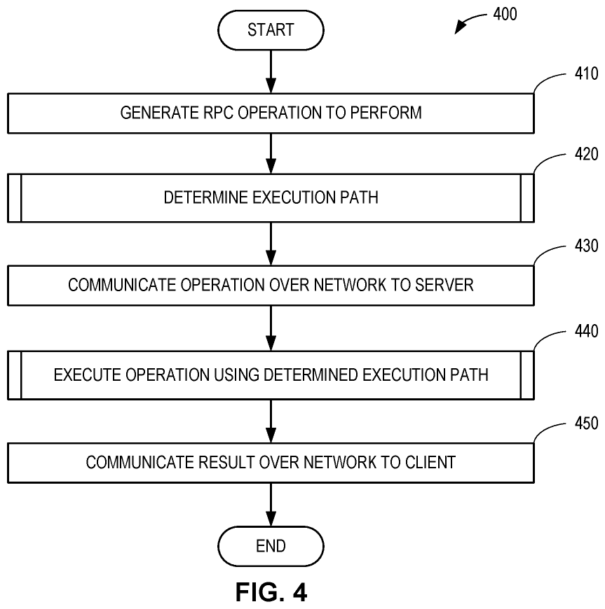

The client business logic circuitry 140 generates an operation to be executed by the server 120. In some examples, the client business logic circuitry 140 includes an offload engine library 280. The offload engine library 280 interfaces with the IPU 145 via the offload engine driver 210. In some examples, the offload engine library 280 generates the RPC call that is communicated to the server 120, the RPC call including the operation to be performed/executed. In some examples, the client business logic circuitry 140 is instantiated by programmable circuitry executing client business logic instructions and/or configured to perform operations such as those represented by the flowchart of FIG. 4.

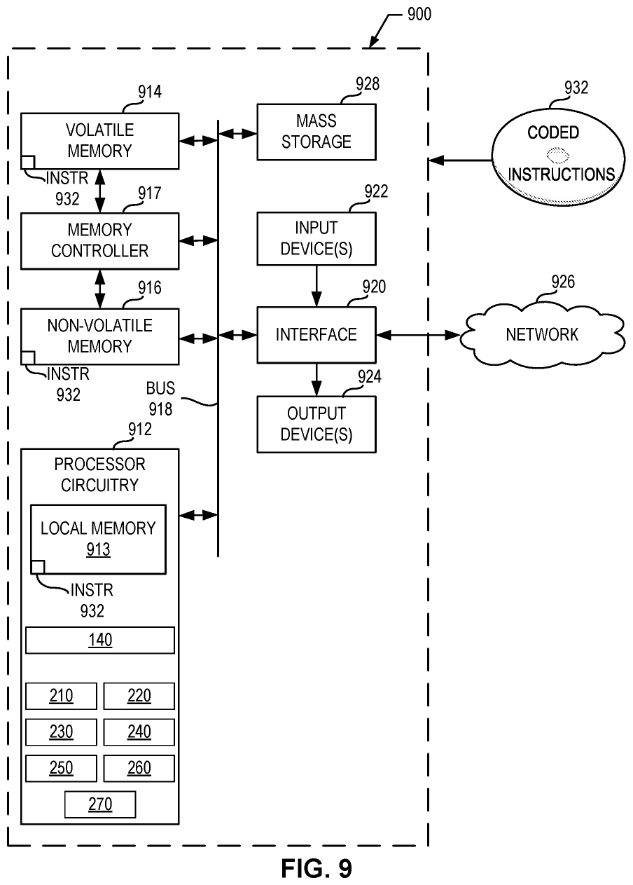

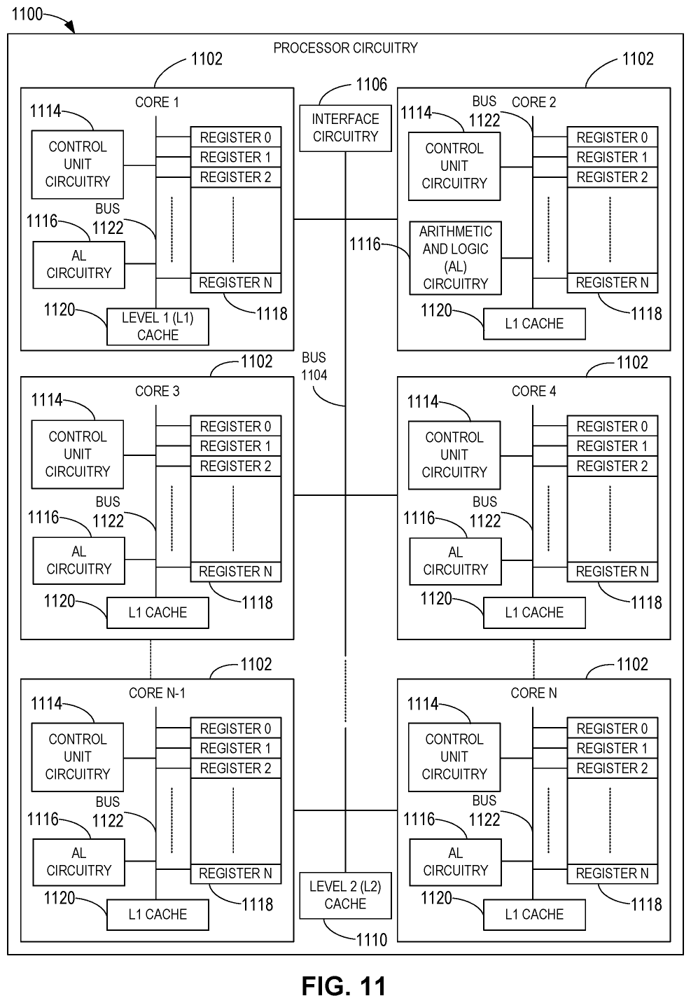

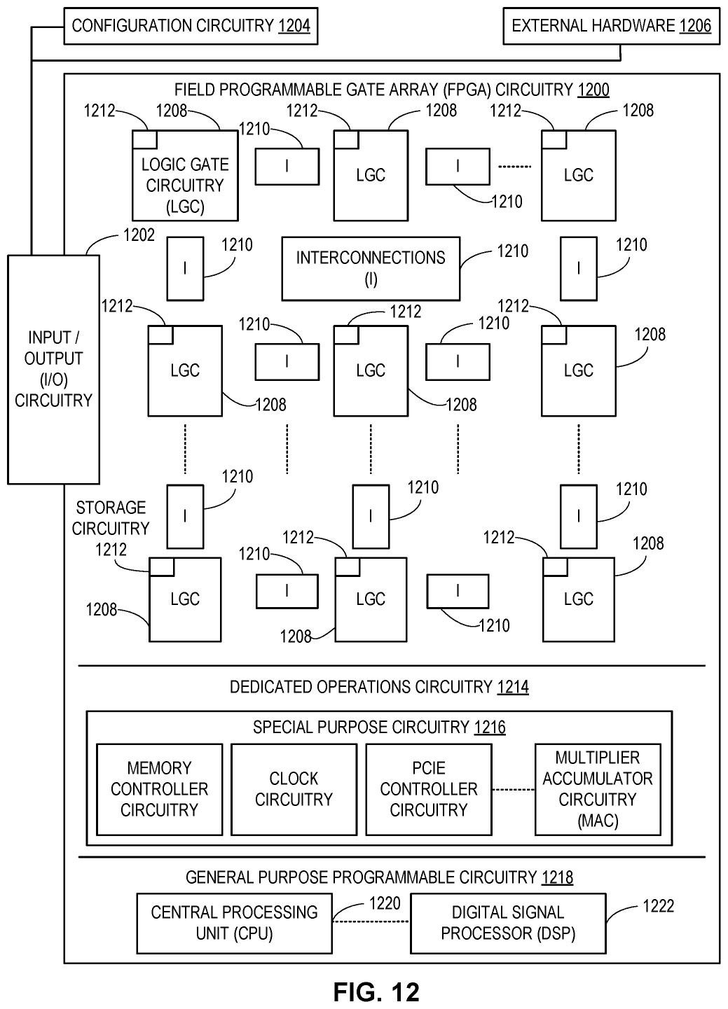

In some examples, the client device 110 includes means for generating an operation to be executed/performed. For example, the means for generating may be implemented by client business logic circuitry 140. In some examples, the client business logic circuitry 140 may be instantiated by programmable circuitry such as the example programmable circuitry 912 of FIG. 9. For instance, the client business logic circuitry 140 may be instantiated by the example microprocessor 1100 of FIG. 11 executing machine executable instructions such as those implemented by at least block 410 of FIG. 4. In some examples, client business logic circuitry 140 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the client business logic circuitry 140 may be instantiated by any other combination of hardware, software, and/or firmware. For example, the client business logic circuitry 140 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

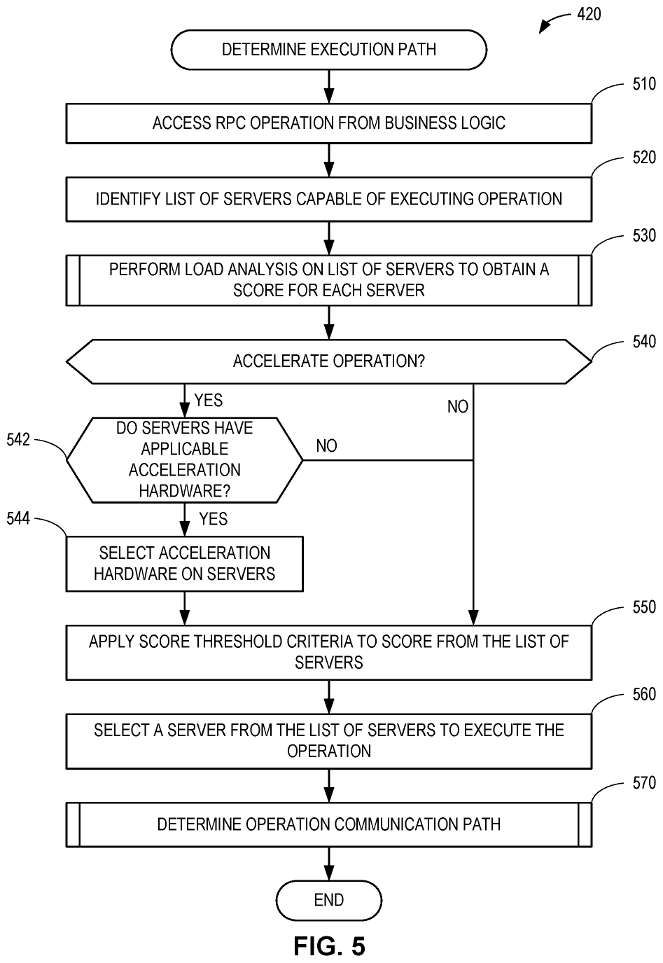

The offload engine driver 210 accesses the RPC call from the client business logic circuitry 140. In some examples, the offload engine driver 210 is instantiated by programmable circuitry executing offload engine driver instructions and/or configured to perform operations such as those represented by the flowchart of FIG. 5.

In some examples, the client device 110 includes means for accessing an RPC call, including an operation, from the client business logic circuitry 140. For example, the means for accessing may be implemented by offload engine driver 210. In some examples, the offload engine driver 210 may be instantiated by programmable circuitry such as the example programmable circuitry 912 of FIG. 9. For instance, the offload engine driver 210 may be instantiated by the example microprocessor 1100 of FIG. 11 executing machine executable instructions such as those implemented by at least block 510 of FIG. 5. In some examples, offload engine driver 210 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the offload engine driver 210 may be instantiated by any other combination of hardware, software, and/or firmware. For example, the offload engine driver 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The server identification circuitry 220 identifies a list of servers capable of executing the operation (e.g., compatible servers). In some examples, the server identification circuitry 220 is instantiated by programmable circuitry executing server identification instructions and/or configured to perform operations such as those represented by the flowchart of FIG. 5.

In some examples, the client device 110 includes means for identifying a list of servers capable of executing the operation. For example, the means for identifying may be implemented by server identification circuitry 220. In some examples, the server identification circuitry 220 may be instantiated by programmable circuitry such as the example programmable circuitry 912 of FIG. 9. For instance, the server identification circuitry 220 may be instantiated by the example microprocessor 1100 of FIG. 11 executing machine executable instructions such as those implemented by at least block 520 of FIG. 5. In some examples, server identification circuitry 220 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the server identification circuitry 220 may be instantiated by any other combination of hardware, software, and/or firmware. For example, the server identification circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The load analyzer circuitry 230 performs a load analysis on the list of compatible servers to assist in selecting the server 120 for executing the operation. In some examples, the load analyzer circuitry 230 is instantiated by programmable circuitry executing load sharing analyzer instructions and/or configured to perform operations such as those represented by the flowchart(s) of FIG. 5 and/or 7.

In some examples, the client device 110 includes means for performing a load analysis on the list of compatible servers. For example, the means for performing may be implemented by load analyzer circuitry 230. In some examples, the load analyzer circuitry 230 may be instantiated by programmable circuitry such as the example programmable circuitry 912 of FIG. 9. For instance, the load analyzer circuitry 230 may be instantiated by the example microprocessor 1100 of FIG. 11 executing machine executable instructions such as those implemented by at least blocks 530 of FIGS. 5 and 710, 720, 730, 740, 745, 750, and 760. In some examples, load analyzer circuitry 230 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the load analyzer circuitry 230 may be instantiated by any other combination of hardware, software, and/or firmware. For example, the load analyzer circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The acceleration determination circuitry 240 determines whether the operation is to be accelerated on the server 120 (e.g., RPC acceleration). In some examples, the acceleration determination circuitry 240 is instantiated by programmable circuitry executing acceleration determination instructions and/or configured to perform operations such as those represented by the flowchart of FIG. 5.

In some examples, the client device 110 includes means for determining whether the operation is to be accelerated on the server 120. For example, the means for determining may be implemented by acceleration determination circuitry 240. In some examples, the acceleration determination circuitry 240 may be instantiated by programmable circuitry such as the example programmable circuitry 912 of FIG. 9. For instance, the acceleration determination circuitry 240 may be instantiated by the example microprocessor 1100 of FIG. 11 executing machine executable instructions such as those implemented by at least blocks 540, 542, and 544 of FIG. 5. In some examples, acceleration determination circuitry 240 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the acceleration determination circuitry 240 may be instantiated by any other combination of hardware, software, and/or firmware. For example, the acceleration determination circuitry 240 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The server score application circuitry 250 applies a score threshold to a calculated score for each server on the list of servers. In some examples, the server score application circuitry 250 is instantiated by programmable circuitry executing server score application instructions and/or configured to perform operations such as those represented by the flowchart of FIG. 5.

In some examples, the client device 110 includes means for applying a score threshold to a score calculated for each server on the list of servers. For example, the means for applying may be implemented by server score application circuitry 250. In some examples, the server score application circuitry 250 may be instantiated by programmable circuitry such as the example programmable circuitry 912 of FIG. 9. For instance, the server score application circuitry 250 may be instantiated by the example microprocessor 1100 of FIG. 11 executing machine executable instructions such as those implemented by at least block 550 of FIG. 5. In some examples, server score application circuitry 250 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the server score application circuitry 250 may be instantiated by any other combination of hardware, software, and/or firmware. For example, the server score application circuitry 250 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The server selection circuitry 260 selects a server from the list of servers for executing the operation. In some examples, the server selection circuitry 260 is instantiated by programmable circuitry executing server selection instructions and/or configured to perform operations such as those represented by the flowchart of FIG. 5.

In some examples, the client device 110 includes means for selecting a server for executing the operation. For example, the means for selecting may be implemented by server selection circuitry 260. In some examples, the server selection circuitry 260 may be instantiated by programmable circuitry such as the example programmable circuitry 912 of FIG. 9. For instance, the server selection circuitry 260 may be instantiated by the example microprocessor 1100 of FIG. 11 executing machine executable instructions such as those implemented by at least block 560 of FIG. 5. In some examples, server selection circuitry 260 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the server selection circuitry 260 may be instantiated by any other combination of hardware, software, and/or firmware. For example, the server selection circuitry 260 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The IPU-network interface circuitry 270 determines an operation communication path to communicate the operation to the server 120. In some examples, IPU-network interface circuitry 270 is instantiated by programmable circuitry executing IPU-network interface instructions and/or configured to perform operations such as those represented by the flowchart(s) of FIG. 5 and/or 8.

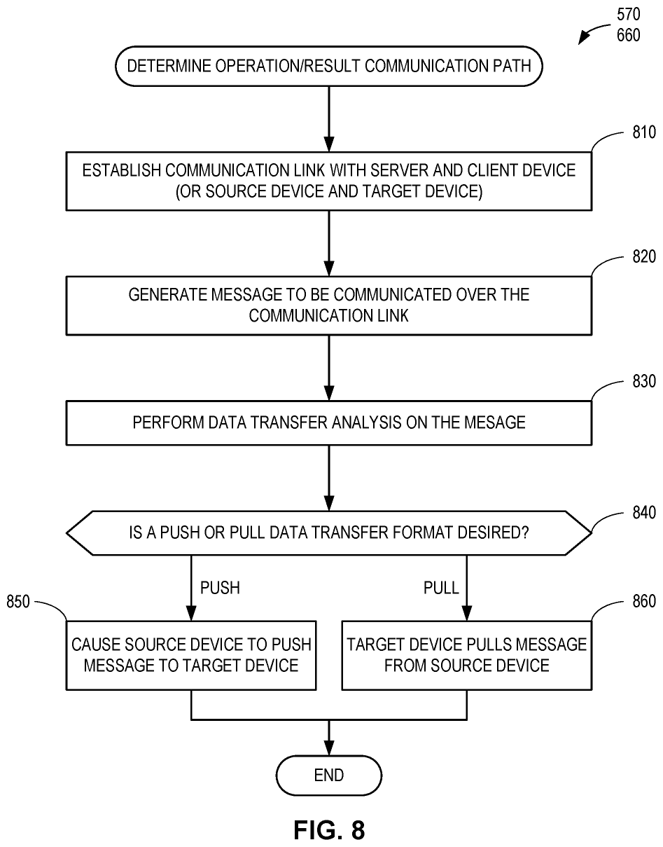

In some examples, the client device 110 includes means for determining an operation communication path. For example, the means for determining may be implemented by IPU-network interface circuitry 270. In some examples, the IPU-network interface circuitry 270 may be instantiated by programmable circuitry such as the example programmable circuitry 912 of FIG. 9. For instance, the IPU-network interface circuitry 270 may be instantiated by the example microprocessor 1100 of FIG. 11 executing machine executable instructions such as those implemented by at least blocks 570 of FIGS. 5 and 810, 820, 830, 840, 850, and 860 of FIG. 8. In some examples, IPU-network interface circuitry 270 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the IPU-network interface circuitry 270 may be instantiated by any other combination of hardware, software, and/or firmware. For example, the IPU-network interface circuitry 270 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the IPU-network interface circuitry 270 implements means for causing communication of the operation to the server 120 (e.g., a destination). In such examples, the IPU-network interface circuitry 270 causes the client network interface circuitry 160 to communicate the operation to the server 120 via the network 130.

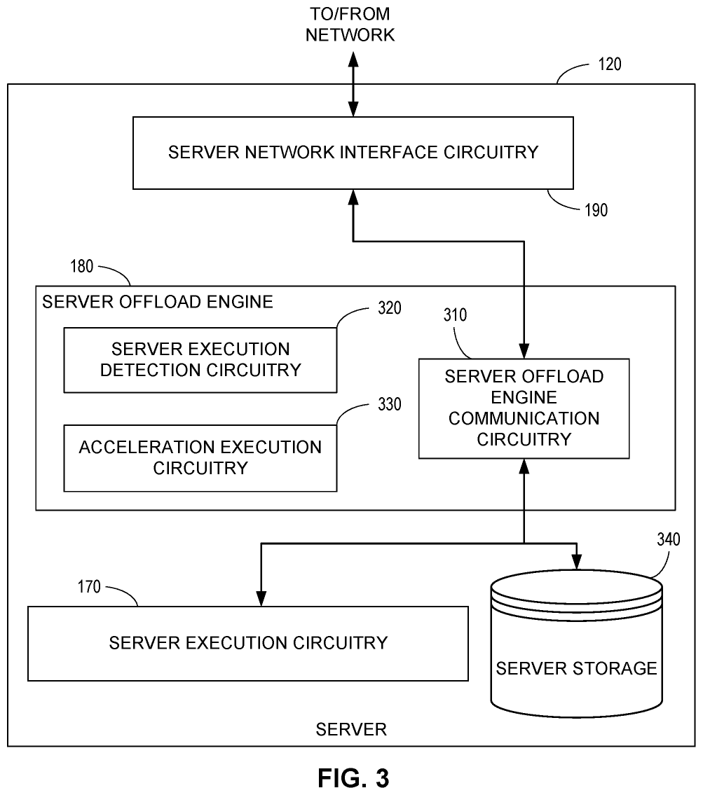

FIG. 3 is a block diagram of an example implementation of the example server 120 of FIG. 1 to execute the operation. The server 120 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the server 120 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

The example server 120 includes the server execution circuitry 170, the server offload engine 180, and the server network interface circuitry 190. The server offload engine 180 includes server offload engine communication circuitry 310, server execution detection circuitry 320, and acceleration execution circuitry 330. In some examples, the example server 120 includes a server storage 340.

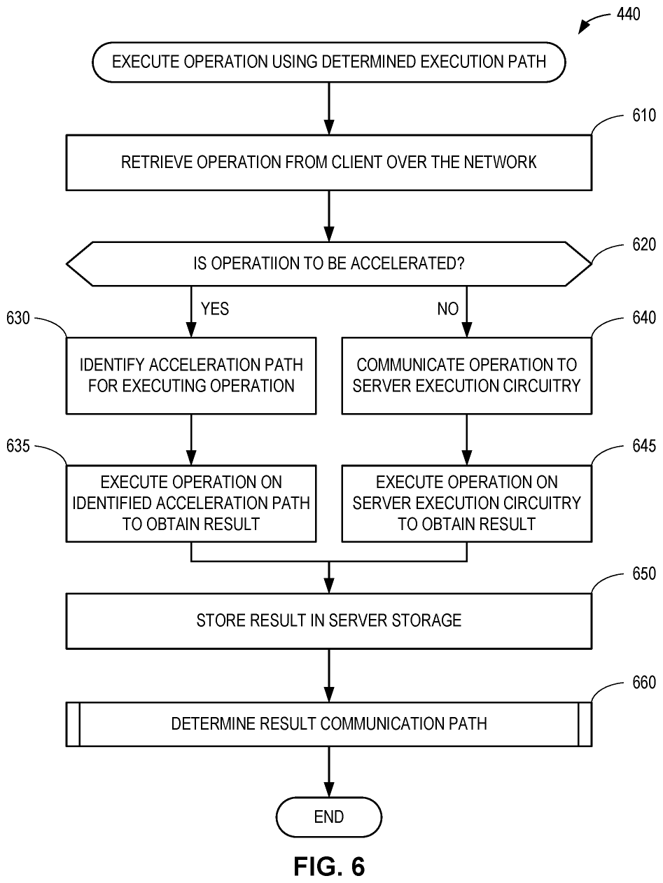

The server execution circuitry 170 executes the operation when it is determined that the operation is not to be accelerated. In some examples, the server execution circuitry 170 is instantiated by programmable circuitry executing server software instructions and/or configured to perform operations such as those represented by the flowchart of FIG. 6.

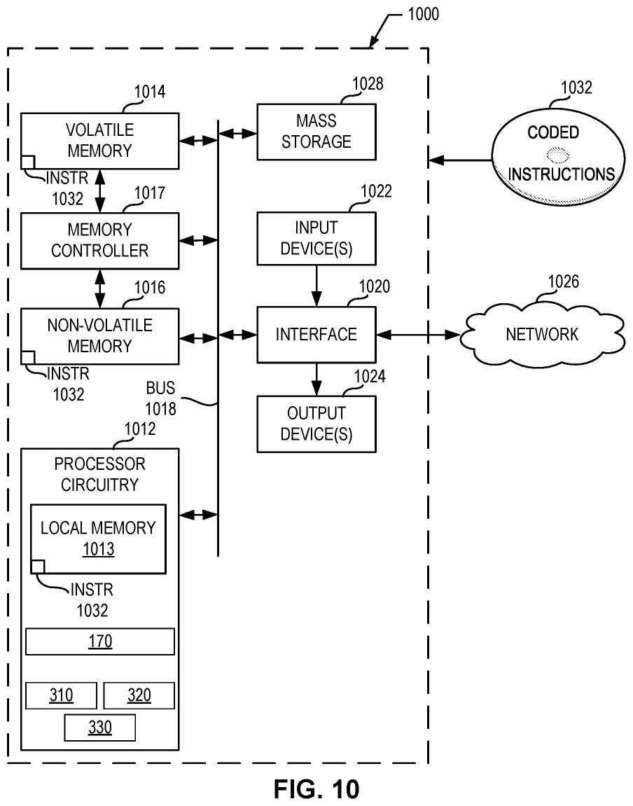

In some examples, the server 120 includes means for executing the operation based on a non-accelerated execution path. For example, the means for executing may be implemented by server execution circuitry 170. In some examples, the server execution circuitry 170 may be instantiated by programmable circuitry such as the example programmable circuitry 1012 of FIG. 10. For instance, the server execution circuitry 170 may be instantiated by the example microprocessor 1100 of FIG. 11 executing machine executable instructions such as those implemented by at least block 645 of FIG. 6. In some examples, the server execution circuitry 170 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the server execution circuitry 170 may be instantiated by any other combination of hardware, software, and/or firmware. For example, the server execution circuitry 170 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The server offload engine communication circuitry 310 retrieves the operation from the client device 110, determines a result communication path for communicating a result to the client device 110, and communicates the operation to the server execution circuitry 170 when the execution path is non-accelerated. In some examples, the server offload engine communication circuitry 310 is instantiated by programmable circuitry executing server offload engine communication instructions and/or configured to perform operations such as those represented by the flowchart of FIG. 6.

In some examples, the server 120 includes means for retrieving the operation from the client device 110. For example, the means for retrieving may be implemented by server offload engine communication circuitry 310. In some examples, the server offload engine communication circuitry 310 may be instantiated by programmable circuitry such as the example programmable circuitry 1012 of FIG. 10. For instance, the server offload engine communication circuitry 310 may be instantiated by the example microprocessor 1100 of FIG. 11 executing machine executable instructions such as those implemented by at least block 610 of FIG. 6. In some examples, the server offload engine communication circuitry 310 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the server offload engine communication circuitry 310 may be instantiated by any other combination of hardware, software, and/or firmware. For example, the server offload engine communication circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the server 120 includes means for determining a result communication path for communicating a result (e.g., an answer/response to the operation) to the client device 110. For example, the means for determining may be implemented by server offload engine communication circuitry 310. In some examples, the server offload engine communication circuitry 310 may be instantiated by programmable circuitry such as the example programmable circuitry 1012 of FIG. 10. For instance, the server offload engine communication circuitry 310 may be instantiated by the example microprocessor 1100 of FIG. 11 executing machine executable instructions such as those implemented by at least blocks 650 and 660 of FIG. 6. In some examples, the server offload engine communication circuitry 310 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the server offload engine communication circuitry 310 may be instantiated by any other combination of hardware, software, and/or firmware. For example, the server offload engine communication circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the server 120 includes means for communicating the operation to the server execution circuitry 170 for execution on a non-acceleration path. For example, the means for communicating may be implemented by server offload engine communication circuitry 310. In some examples, the server offload engine communication circuitry 310 may be instantiated by programmable circuitry such as the example programmable circuitry 1012 of FIG. 10. For instance, the server offload engine communication circuitry 310 may be instantiated by the example microprocessor 1100 of FIG. 11 executing machine executable instructions such as those implemented by at least block 640 of FIG. 6. In some examples, the server offload engine communication circuitry 310 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the server offload engine communication circuitry 310 may be instantiated by any other combination of hardware, software, and/or firmware. For example, the server offload engine communication circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The server execution detection circuitry 320 detects/identifies the execution path for the operation. In some examples, the server execution detection circuitry 320 is instantiated by programmable circuitry executing server execution detection instructions and/or configured to perform operations such as those represented by the flowchart of FIG. 6.

In some examples, the server 120 includes means for detecting the execution path for the operation. For example, the means for detecting may be implemented by server execution detection circuitry 320. In some examples, the server execution detection circuitry 320 may be instantiated by programmable circuitry such as the example programmable circuitry 1012 of FIG. 10. For instance, the server execution detection circuitry 320 may be instantiated by the example microprocessor 1100 of FIG. 11 executing machine executable instructions such as those implemented by at least blocks 620 and 630 of FIG. 6. In some examples, the server execution detection circuitry 320 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the server execution detection circuitry 320 may be instantiated by any other combination of hardware, software, and/or firmware. For example, the server execution detection circuitry 320 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The acceleration execution circuitry 330 executes the operation on the accelerated execution path. In some examples, the acceleration execution circuitry 330 is instantiated by programmable circuitry executing acceleration execution instructions and/or configured to perform operations such as those represented by the flowchart of FIG. 6.

In some examples, the server 120 includes means for executing the operation on the accelerated execution path. For example, the means for executing may be implemented by acceleration execution circuitry 330. In some examples, the acceleration execution circuitry 330 may be instantiated by programmable circuitry such as the example programmable circuitry 1012 of FIG. 10. For instance, the acceleration execution circuitry 330 may be instantiated by the example microprocessor 1100 of FIG. 11 executing machine executable instructions such as those implemented by at least block 635 of FIG. 6. In some examples acceleration execution circuitry 330 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the acceleration execution circuitry 330 may be instantiated by any other combination of hardware, software, and/or firmware. For example, the acceleration execution circuitry 330 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the example offload environment 100 of FIG. 1 is illustrated in FIGS. 2 and/or 3, one or more of the elements, processes, and/or devices illustrated in FIGS. 2 and/or 3 may be combined, divided, re-arranged, omitted, eliminated, and/or implemented in any other way. Further, the example client business logic circuitry 140, offload engine driver 210, server identification circuitry 220, load analyzer circuitry 230, acceleration determination circuitry 240, server score application circuitry 250, server selection circuitry 260, IPU-network interface circuitry 270, the offload engine library 280 and/or, more generally, the example client device 110 of FIG. 2, and/or the example server execution circuitry 170, server offload engine communication circuitry 310, server execution detection circuitry 320, acceleration execution circuitry 330, and/or, more generally, the example server 120 of FIG. 3, may be implemented by hardware alone or by hardware in combination with software and/or firmware. Thus, for example, any of the example client business logic circuitry 140, server execution circuitry 170, offload engine driver 210, server identification circuitry 220, load analyzer circuitry 230, acceleration determination circuitry 240, server score application circuitry 250, server selection circuitry 260, IPU-network interface circuitry 270, offload engine library 280, server offload engine communication circuitry 310, server execution detection circuitry 320, acceleration execution circuitry 330, and/or, more generally, the example client device 110 and/or the example server 120, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example client device 110 and/or the example server 120 of FIGS. 2 and/or 3 may include one or more elements, processes, and/or devices in addition to, or instead of, those illustrated in FIGS. 2 and/or 3, and/or may include more than one of any or all of the illustrated elements, processes and devices.

Flowchart(s) representative of example machine readable instructions, which may be executed by programmable circuitry to implement and/or instantiate the example client device 110 and/or the example server 120 of FIGS. 2 and/or 3 and/or representative of example operations which may be performed by programmable circuitry to implement and/or instantiate the example client device 110 and/or the example server 120 of FIGS. 2 and/or 3, are shown in FIGS. 4-8. The machine readable instructions may be one or more executable programs or portion(s) of one or more executable programs for execution by programmable circuitry such as the processor circuitry 912, 1012 shown in the example processor platform 900, 1000 discussed below in connection with FIGS. 9 and/or 10 and/or may be one or more function(s) or portion(s) of functions to be performed by the example programmable circuitry (e.g., an FPGA) discussed below in connection with FIGS. 11 and/or 12. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4-8, many other methods of implementing the example client device 110 and/or the example server 120 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4-8 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 4 is a flowchart representative of example machine readable instructions and/or example operations that may be executed, instantiated, and/or performed by programmable circuitry to implement the example offload environment 100 of FIG. 1. The example offload environment process 400 of FIG. 4 begins at block 410, at which the client business logic circuitry 140 generates an RPC operation to be executed. In some examples, the client business logic circuitry 140 generates an operation that is defined by a user asking a question (e.g., what color is the sky?, etc.) or a remote operation to be performed by the server 120.

Once the operation is generated by the client business logic circuitry 140, the RPC offload circuitry 150 determines an execution path to execute the operation. (Block 420). In some examples, the execution path includes a wholly software implementation (e.g., a software stack running on a generic server 120). In other examples, the execution path includes a combination of a software and a hardware implementation path (e.g., a software stack running on a dedicated hardware piece such as an IPU, a wholly hardware implementation on a server 120, etc.). In some examples, the execution path includes using RDMA for executing/performing the operation. In some examples, the execution path determination is dependent on whether the operation can or should be accelerated (e.g., the execution of the operation is sped-up using dedicated hardware on the server 120, a server that has a low current or future workload, use a remote direct memory access (RDMA) communication protocol to accelerate a data transfer on the server, etc.).

Once the execution path is determined by the RPC offload circuitry 150, the client network interface circuitry 160 communicates the operation to the server 120 via the network 130. (Block 430). In some examples, the communication of the operation to the server 120 is dependent on the chosen execution path from the client offload engine 140. Such an example may include assigning a weight to each server 120 capable of executing the operation and determining which server 120 to communicate the operation to based on the weight and the chosen execution path. The communication determination (e.g., a communication path) is further disclosed herein in reference to FIG. 8.

Once the operation is communicated to the server 120 by the client network interface circuitry 160, the server offload engine 180 and/or the server execution circuitry 170 executes the operation using the determined execution path to obtain a result. (Block 440). In some examples, the server 120 identifies the determined execution path from the client device 110 and determines how the operation is to be executed. Such an example may include identifying whether the operation is to be accelerated (as determined by the RPC offload circuitry 150) and detecting the appropriate hardware/software to execute the operation. In some examples, where the operation is wholly implemented in software, the server 120 may determine that the server execution circuitry 170 is adequately equipped to execute the operation (e.g., the operation is simplistic, the server execution circuitry 170 specializes in executing the operation, etc.). In some examples, where the operation is to be implemented with a combination of hardware and software, the server offload engine 180 may include specialized hardware (e.g., IPUs using RDMA) for accelerating the execution of the operation.

Once the operation has been executed by the server offload engine 180 or the server execution circuitry 170, the result is then communicated back to the client device 110 by the server network interface circuitry 190 over the network 130. (Block 450). In some examples, the communication of the result back to the client device 110 follows a similar determination as the communication of the operation to the server 120 from block 430. Such a determination may include identifying how to reduce latency to communicate the result to the client device 110 in as short a time as possible. Once the result is communicated back to the client device 110, the example offload environment process 400 ends.

In some examples, the operations of blocks 410-450 is executed using a machine learning model/neural network. In such an example, the client device 110 acts as a student network that is accessing a trained teacher model from the server 120. In some examples, the client device 110 assists in training a teacher model on the server 120 for producing a result for the operation. Thus, it should be understood that the example machine readable instructions/operations disclosed herein may be implemented using a machine learning model/neural network for executing the operation.

FIG. 5 is a flowchart representative of example machine readable instructions and/or example operations that may be executed, instantiated, and/or performed by programmable circuitry to implement the example RPC offload circuitry 150 of FIG. 2 to determine the execution path for the operation. The example execution path determination process 420 of FIG. 5 begins at block 510, at which the offload engine driver 210 accesses the RPC operation from the client business logic circuitry 140. In some examples, the client business logic circuitry 140 translates a question asked by a user into a machine readable instruction (e.g., a binary representation of the question, a hexadecimal code mapped to specific commands, etc.) which can be executed by the server 120. In such an example, the offload engine driver 210 accesses the translated operation for execution.

Once the operation is accessed by the offload engine driver 210, the server identification circuitry 220 identifies servers capable of executing the operation. (Block 520). In some examples, the servers may be identified in the form of a list, however any other structure for identifying one or more servers capable of executing the operation may additionally or alternatively be used such as a buffer, array, string, etc. In some examples, an environment (e.g., a client to server environment) includes multiple servers 120 for which the operation may be executed on. In such an example, the server identification circuitry 220 identifies which servers of the multiple servers can execute the operation (e.g., which servers have appropriate programming to execute the operation, which servers can access the database(s) which house the answer to the operation, which servers include the ability to perform the operation using RDMA, etc.).

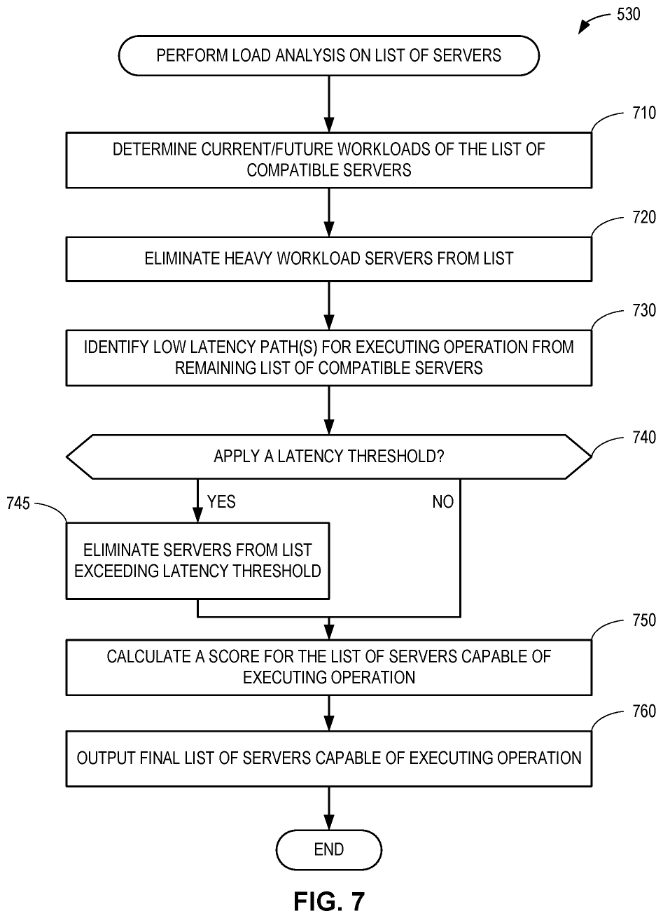

Once the list/plurality of servers has been identified by the server identification circuitry 220, the load analyzer circuitry 230 performs a load analysis on the list of servers to obtain a score for each of the servers. (Block 530). In some examples, the load analysis includes multiple determinations/questions/criteria for which the servers are weighed against to determine which servers are most capable to execute the operation. Such an example narrows down the list of servers into a smaller, more manageable list of servers for which to select the one server 120 to execute the operation. The load analysis is disclosed in further detail herein with reference to FIG. 7.

Once the load analysis has been performed on the list of servers by the load analyzer circuitry 230, the acceleration determination circuitry 240 determines whether the operation should be accelerated. (Block 540). In some examples, the operation is accelerated when a low latency result is desired (e.g., less time between asking question and receiving result), where the servers capable of executing the operation have acceleration hardware (e.g., IPUs), where servers are experiencing low workloads, etc. The determination of whether to accelerate the operation (e.g., an RPC call) is tunable such that more or less functionality (e.g., commands, machine readable instructions, etc.) can be accelerated using multiple factors such as current or future server workloads, availability of acceleration hardware, complexity of the operation, etc. Such an acceleration is also referred to as an RPC acceleration.

When the acceleration determination circuitry 240 determines that the operation is to be accelerated (e.g., block 540 returns a result of YES), then the acceleration determination circuitry 240 determines whether the servers identified have applicable acceleration hardware. (Block 542). In some examples, the operation is executed quickly (e.g., lowest latency time) when using acceleration hardware on the server 120. In other examples, the acceleration hardware may not be capable of performing the operation to decrease latency (e.g., the acceleration hardware is busy executing other tasks, the acceleration hardware is not capable of executing the operation (e.g., the acceleration hardware was designed and implemented to execute specific operations), etc.). As such, the acceleration determination circuitry 240 determines whether the servers have applicable acceleration hardware for accelerating the operation.

When the acceleration determination circuitry 240 determines that the servers do have applicable acceleration hardware that is capable of executing the operation to reduce latency (e.g., block 542 returns a result of YES), then the acceleration determination circuitry 240 selects the acceleration hardware of the servers. (Block 544). In some examples, the selection of the acceleration hardware is added/aggregated to the weight/score calculated by the load analyzer circuitry 230. Such an example may further narrow down potential servers to select, create outliers in the list of servers so the selection of the server 120 is easier, etc.

When the acceleration hardware has been selected by the acceleration determination circuitry 240, or when the acceleration determination circuitry 240 determines that the servers do not have applicable acceleration hardware (e.g., block 542 returns a result of NO), or when the acceleration determination circuitry 240 determines that the operation should not be accelerated (e.g., block 540 returns a result of NO), then the server score application circuitry 250 applies a score threshold to the scores on the list of servers. (Block 550). In some examples, the score threshold includes a latency threshold for the server 120 selected to stay under. In some examples, the score threshold may include an aggregation of multiple factors such as latency, ability to accelerate the operation, position on the list, communication protocol available (e.g., RDMA), current/future workload, etc.

In some examples, the operations of blocks 540, 542, and 544 come before the load analysis of the load sharing analyzer circuitry 240. Such an example may be application-specific (e.g., dependent on the operation to be executed, the capability of the servers identified, etc.). Thus, it is possible to narrow down the list of servers identified by the server identification circuitry 220 prior to performing the load analysis.

Once the score threshold is applied to the list of servers by the server score application circuitry 250, the server selection circuitry 260 selects the server 120 to execute the operation. (Block 560). In some examples, the score and the score threshold indicate which server 120 to select. In some examples, multiple different factors are used to select the server 120 such as whether the operation is to be accelerated, the load analysis of block 530, the identification of acceleration hardware of block 544, etc.

Once the server 120 is selected by the server selection circuitry 260, the IPU-network interface circuitry 270 determines an operation communication path to communicate the operation to the server 120. (Block 570). In some examples, the operation includes too much data to be able to send across the network 130 to the server 120. Such an example may include an additional analysis of which communication path should be used to communicate the operation to the server 120 while reducing latency. Once the operation communication path is determined, the example execution path determination process 420 ends.

FIG. 6 is a flowchart representative of example machine readable instructions and/or example operations that may be executed, instantiated, and/or performed by programmable circuitry to implement the example server offload engine 180 of FIG. 3 to execute the operation using the determined execution path. The example query execution process 440 of FIG. 6 begins at block 610, at which the server offload engine communication circuitry 310 retrieves the operation from the client device 110 via the server network interface circuitry 190.

When the operation is retrieved by the server offload engine communication circuitry 310, the server execution detection circuitry 320 identifies whether the operation is to be accelerated (e.g., identify the execution path). (Block 620). In some examples, the execution path is communicated to the server 120 with the operation (e.g., on the same message communicated over the network 130). In some examples, the execution path is concatenated onto the operation and then retrieved by the server 120.

When the server execution detection circuitry 320 determines that the operation is to be accelerated (e.g., block 620 returns a result of YES), the server execution detection circuitry 320 identifies the acceleration execution path on the server 120 for executing the operation. (Block 630). In some examples, the server 120 includes multiple IPUs or acceleration hardware components for accelerating an operation. In such an example, the server execution detection circuitry 320 determines which acceleration hardware component to identify for executing the operation. In some examples, the acceleration execution path includes software being executed on the acceleration hardware.

Once the acceleration execution path has been identified by the server execution detection circuitry 320, the acceleration execution circuitry 330 executes the operation on the identified acceleration execution path to obtain a result. (Block 635). In some examples, the result is obtained by communicating with databases which contain the answer to the question. In other examples, the result is obtained by executing a series of commands on the data from the operation (e.g., processing an image, analyzing a computation, etc.).

When the server execution detection circuitry 320 determines that the operation is not to be accelerated (e.g., block 620 returns a result of NO), the server offload engine communication circuitry 310 communicates the operation to the server execution circuitry 170 for executing the operation. (Block 640). In some examples, the server 120 contains base (e.g., generic across a suite of servers) software for executing operations. In such an example, the execution path determined by the RPC offload circuitry 150 identifies the server 120 capable of executing the operation the quickest without accelerating the operation. The server execution circuitry 170 may contain generic instructions for executing the operation to not bog down other processes or hardware on the server 120.

When the operation has been communicated to the server execution circuitry 170 by the server offload engine communication circuitry 310, the server execution circuitry 170 executes the operation to obtain the result. (Block 645). In some examples, the server execution circuitry 170 also communicates with databases which contain the answer to the question. In some examples, the server execution circuitry 170 includes generic hardware for executing operations. Such generic hardware may be used for performing highly repeated tasks such as database recognition tasks, web-based result gathering, etc.

Once the result has been obtained from either the acceleration execution circuitry 330 of block 635 or the server execution circuitry 170 of block 645, the server offload engine communication circuitry 310 can then store the result in the server storage 340. (Block 650). In some examples, the storage of the result in the server storage 340 is desired to improve latency times on subsequent query executions by training a machine learning model/neural network to predict results based on the operation received. In other examples, the storage of the result is desired to maintain a log of completed query executions, the time taken to execute the operation, the result of the operation execution, the acceleration hardware used, etc. In some examples, the storage of the result is not desired and may be skipped (e.g., to reduce storage size, to offload the server 120, etc.).

Once the result is stored in the server storage 340, the server offload engine communication circuitry 310 determines a result communication path to communicate the result back to the client device 110. (Block 660). In some examples, the communication path is determined using the same method of determining the communication path for communicating the operation to the server 120 in the RPC offload circuitry 150. In other examples, the communication path is determined independently/separately from the operation communication path. Once the result communication path is determined, the example query execution process 440 ends.

FIG. 7 is a flowchart representative of example machine readable instructions and/or example operations that may be executed, instantiated, and/or performed by programmable circuitry to implement the example load analyzer circuitry 230 of FIG. 2 to perform a load analysis on the list of servers capable of executing the operation. The example load sharing process 530 of FIG. 7 begins at block 710, at which the load analyzer circuitry 230 determines current and/or future workloads of the list of compatible servers. In some examples, servers may be queued up to perform certain tasks on a regular basis (e.g., every hour, every day, every week, etc.) and may be predicted by the load analyzer circuitry 230 to determine which servers may be unable to execute the operation. In some examples, the current workload includes the intensity of current tasks being performed by the servers and the intensity/length of the execution of those tasks.

Once the current and/or future workloads of the list of servers has been determined, the load analyzer circuitry 230 then eliminates servers indicating heavy current and/or future workloads from the list of servers. (Block 720). In some examples, a workload threshold (e.g., a CPU utilization, memory utilization, etc.) indicates how heavy a workload is before the server is eliminated from the list of servers. In other examples, any server currently performing or scheduled to perform a workload is eliminated from the list of servers.

When the heavy workload servers are eliminated from the list of servers, the load analyzer circuitry 230 then identifies potential low latency paths for executing the operation. (Block 730). In some examples, it is desired to return the result to the operation in a time dictated by the complexity of the operation, the urgency of the result, etc. In such an example, the load analyzer circuitry 230 can identify low latency paths by identifying which servers are not executing any tasks, have ample computing headroom for executing the operation, etc. Thus, some servers can be identified as more desirable candidates based on a multitude of factors.

Once the low latency paths have been identified, the load analyzer circuitry 230 determines whether to apply a latency threshold to the remaining list of servers. (Block 740). In some examples, the operation execution needs to be completed in a certain timeframe (e.g., less than 100 milliseconds), and servers that are predicted to exceed that timeframe may be undesirable to choose as the server 120 to execute the operation.

When the load analyzer circuitry 230 determines that a latency threshold is to be applied to the remaining list of servers (e.g., block 740 returns a result of YES), the load analyzer circuitry 230 applies the latency threshold and eliminates servers from the remaining list of servers exceeding the latency threshold. (Block 745). In some examples, the latency threshold is a timed threshold (e.g., 100 milliseconds).

When the servers have been eliminated for exceeding the latency threshold or when the load analyzer circuitry 230 determines that a latency threshold is not to be applied (e.g., block 740 returns a result of NO), then the load analyzer circuitry 230 calculates a score for the remaining list of servers capable of executing the operation. (Block 750). In some examples, the score is a weight of how likely a server is to be selected to execute the operation. In such an example, the score is calculated through at least one of, but not exclusively, the latency threshold, the current/future workloads, the communication protocol, the complexity of the operation, etc. In some examples, the score may be calculated using a machine learning model/neural network for calculating the ability (e.g., speed, efficiency, etc.) of the servers to execute the operation.

Once the score is calculated for each server on the remaining list of servers, the load analyzer circuitry 230 outputs the final list of servers capable of executing the operation. (Block 760). In some examples, the final list of servers may include a single server (e.g., the server 120). In other examples, multiple servers may still be desirable, and the server selection circuitry 260 selects the server 120 from the final list of servers from block 560 above. Once the final list of servers capable of executing the operation has been outputted, the example load sharing process 530 ends.

FIG. 8 is a flowchart representative of example machine readable instructions and/or example operations that may be executed, instantiated, and/or performed by programmable circuitry to implement the example IPU-network interface circuitry 270 of FIG. 2 and the example server offload engine communication circuitry 310 of FIG. 3 (e.g., communication circuitry 270, 310) to determine the operation communication path and the result communication path. The example query and result communication path determination process 570, 660 of FIG. 8 begin at block 810, at which the communication circuitry 270, 310 establishes a communication link with the server 120 and the client device 110. In the examples disclosed herein, the server 120 and the client device 110 may be referred to as a source device and a target device, and interchangeably used herein as such. In some examples, such as when the client device 110 is communicating the operation, the server 120 is the target device and the client device 110 is the source device. In other examples, such as when the server 120 is communicating the result, the client device 110 is the target device and the server 120 is the source device.

Once the communication link has been established between the source device and the target device, the communication circuitry 270, 310 then generates a message to be communicated over the communication link. (Block 820). In some examples, the message includes the operation, the communication path, and/or any additional information that may be sent to the target device such as source device identification information, required execution time, etc.

Once the message has been generated, the communication circuitry 270, 310 performs a data transfer analysis on the message to determine an appropriate data transfer format. (Block 830). In some examples, the data transfer analysis includes determining how long (e.g., time) it will take to communicate the message from the source device over the network 130 to the target device. In some examples, the data transfer analysis determines the data transfer format (e.g., the source device pushing or communicating the message to the target device, or the target device pulling or retrieving the message from the source device) based upon multiple factors such as latency, message size, complexity of message, network traffic, etc.

When the desired data transfer format has been identified, the communication circuitry 270, 310 determines whether the data transfer format is a push or a pull format. (Block 840). In some examples, the source device pushes the message (e.g., sends the message) to the target device over the network 130. In other examples, the message may include too much data for the source device to push the message over the network 130 to the target device. In such an example, the source device is not able to communicate the message and the target device may need to pull the message (e.g., retrieve the message) from the source device.

When the communication circuitry 270, 310 determines that the data transfer format is a push format (e.g., block 840 returns a result of PUSH), then the communication circuitry 270, 310 causes the source device to push (e.g., communicate) the message to the target device. (Block 850). In some examples, the communication circuitry 270, 310 causes the message to be pushed to the target device over the network 130. In some examples, a communication protocol is used to ensure the message is pushed safely (e.g., using an RDMA protocol).

When the communication circuitry 270, 310 determines that the data transfer format is a pull format (e.g., block 840 returns a result of PULL), then the communication circuitry 270, 310 indicates to the target device to cause the target device to pull (e.g., retrieve) the message from the source device. (Block 860). In some examples, the indication from the source device to the target device includes a trigger message (e.g., a message sent over the network 130 to wake up/alert the target device to pull the message from the source device). When the communication circuitry 270, 310 has caused the message to be pushed or indicated to the target device cause the target device to pull the message, then the example query and result communication path determination process 570, 660 ends.

FIG. 9 is a block diagram of an example programmable circuitry platform 900 structured to execute and/or instantiate the example machine-readable instructions and/or the example operations of FIGS. 4-5 and/or 7-8 to implement the example client device 110 of FIGS. 1 and/or 2. The programmable circuitry platform 900 can be, for example, a personal computer, a workstation, a self-learning machine (e.g., a neural network), a mobile device (e.g., a cell phone, a smart phone, a tablet such as an iPad™), a personal digital assistant (PDA), or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, and/or microcontrollers from any desired family or manufacturer. The programmable circuitry 912 may be implemented by one or more semiconductor based (e.g., silicon based) devices. In this example, the programmable circuitry 912 implements client business logic circuitry 140, client offload engine communication circuitry 210, server identification circuitry 220, load analyzer circuitry 230, acceleration determination circuitry 240, server score application circuitry 250, and server selection circuitry 260.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, InfiniBand, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, InfiniB and, a digital subscriber line (DSL) connection, a telephone line connection, a coaxial cable system, a satellite system, a beyond-line-of-site wireless system, a line-of-site wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 932, which may be implemented by the machine readable instructions of FIGS. 4-5 and/or 7-8, may be stored in the mass storage device 928, in the volatile memory 914, in the non-volatile memory 916, and/or on at least one non-transitory computer readable storage medium such as a CD or DVD which may be removable.

FIG. 10 is a block diagram of an example programmable circuitry platform 1000 structured to execute and/or instantiate the example machine-readable instructions and/or the example operations of FIGS. 6 and/or 8 to implement the example server 120 of FIGS. 1 and/or 3. The programmable circuitry platform 1000 can be, for example, a server, a self-learning machine (e.g., a neural network), or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs, microprocessors, CPUs, GPUs, DSPs, and/or microcontrollers from any desired family or manufacturer. The programmable circuitry 1012 may be implemented by one or more semiconductor based (e.g., silicon based) devices. In this example, the programmable circuitry 1012 implements server execution circuitry 170, server offload engine communication circuitry 310, server execution detection circuitry 320, and acceleration execution circuitry 330.

The programmable circuitry 1012 of the illustrated example includes a local memory 1013 (e.g., a cache, registers, etc.). The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016.

The programmable circuitry platform 1000 of the illustrated example also includes interface circuitry 1020. The interface circuitry 1020 may be implemented by hardware in accordance with any type of interface standard, such as an Ethernet interface, InfiniBand, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, a network interface, a keyboard, a button, a mouse, a touchscreen, a trackpad, and/or any other kind of input device standard on server platforms.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a network interface, and/or any other kind of output device standard on server platforms. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, InfiniB and, a digital subscriber line (DSL) connection, a telephone line connection, a coaxial cable system, a satellite system, a beyond-line-of-site wireless system, a line-of-site wireless system, a cellular telephone system, an optical connection, etc.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1032, which may be implemented by the machine readable instructions of FIGS. 6 and/or 8, may be stored in the mass storage device 1028, in the volatile memory 1014, in the non-volatile memory 1016, and/or on at least one non-transitory computer readable storage medium such as a CD or DVD which may be removable.

FIG. 11 is a block diagram of an example implementation of the programmable circuitry 912, 1012 of FIGS. 9 and/or 10. In this example, the programmable circuitry 912, 1012 of FIGS. 9 and/or 10 is implemented by a microprocessor 1100. For example, the microprocessor 1100 may be a general-purpose microprocessor (e.g., general-purpose microprocessor circuitry). The microprocessor 1100 executes some or all of the machine-readable instructions of the flowcharts of FIGS. 4-8 to effectively instantiate the circuitry of FIGS. 2 and/or 3 as logic circuits to perform operations corresponding to those machine readable instructions. In some such examples, the circuitry of FIGS. 2 and/or 3 is instantiated by the hardware circuits of the microprocessor 1100 in combination with the machine-readable instructions. For example, the microprocessor 1100 may be implemented by multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine readable instructions and/or operations represented by the flowcharts of FIGS. 4-8.

The cores 1102 may communicate by a first example bus 1104. In some examples, the first bus 1104 may be implemented by a communication bus to effectuate communication associated with one(s) of the cores 1102. For example, the first bus 1104 may be implemented by at least one of an Inter-Integrated Circuit (I2C) bus, a Serial Peripheral Interface (SPI) bus, a PCI bus, or a PCIe bus. Additionally or alternatively, the first bus 1104 may be implemented by any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2 cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 914, 916, 1014, 1016 of FIGS. 9 and/or 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the local memory 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer based operations. In other examples, the AL circuitry 1116 also performs floating-point operations. In yet other examples, the AL circuitry 1116 may include first AL circuitry that performs integer-based operations and second AL circuitry that performs floating-point operations. In some examples, the AL circuitry 1116 may be referred to as an Arithmetic Logic Unit (ALU).

The registers 1118 are semiconductor-based structures to store data and/or instructions such as results of one or more of the operations performed by the AL circuitry 1116 of the corresponding core 1102. For example, the registers 1118 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure, such as by being distributed throughout the core 1102 to shorten access time. The second bus 1122 may be implemented by at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages.

The microprocessor 1100 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1100, in the same chip package as the microprocessor 1100 and/or in one or more separate packages from the microprocessor 1100.

FIG. 12 is a block diagram of another example implementation of the programmable circuitry 912, 1012 of FIGS. 9 and/or 10. In this example, the programmable circuitry 912, 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1100 of FIG. 11 executing corresponding machine readable instructions. However, once configured, the FPGA circuitry 1200 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1100 of FIG. 11 described above (which is a general purpose device that may be programmed to execute some or all of the machine readable instructions represented by the flowchart(s) of FIGS. 4-8 but whose interconnections and logic circuitry are fixed once fabricated), the FPGA circuitry 1200 of the example of FIG. 12 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 4-8. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4-8. As such, the FPGA circuitry 1200 may be configured and/or structured to effectively instantiate some or all of the operations/functions corresponding to the machine readable instructions of the flowchart(s) of FIGS. 4-8 as dedicated logic circuits to perform the operations/functions corresponding to those software instructions in a dedicated manner analogous to an ASIC. Therefore, the FPGA circuitry 1200 may perform the operations/functions corresponding to the some or all of the machine readable instructions of FIGS. 4-8 faster than the general-purpose microprocessor can execute the same.

In the example of FIG. 12, the FPGA circuitry 1200 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain a binary file, which may be implemented by a bit stream, data, and/or machine-readable instructions, to configure the FPGA circuitry 1200, or portion(s) thereof. In some such examples, the configuration circuitry 1204 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1206 may be implemented by external hardware circuitry. For example, the external hardware 1206 may be implemented by the microprocessor 1100 of FIG. 11.

The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations/functions that may correspond to at least some of the machine readable instructions of FIGS. 4-8 and/or other desired operations. The logic gate circuitry 1208 shown in FIG. 12 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations/functions. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example dedicated operations circuitry 1214. In this example, the dedicated operations circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the programmable circuitry 912, 1012 of FIGS. 9 and/or 10, many other approaches are contemplated. For example, FPGA circuitry may include an on-board CPU, such as one or more of the example CPU 1220 of FIG. 11. Therefore, the programmable circuitry 912, 1012 of FIG. 9 and/or 10 may additionally be implemented by combining at least the example microprocessor 1100 of FIG. 11 and the example FPGA circuitry 1200 of FIG. 12. In some such hybrid examples, one or more cores 1102 of FIG. 11 may execute a first portion of the machine readable instructions represented by the flowchart(s) of FIGS. 4-8 to perform first operation(s)/function(s), the FPGA circuitry 1200 of FIG. 12 may be configured and/or structured to perform second operation(s)/function(s) corresponding to a second portion of the machine readable instructions represented by the flowcharts of FIG. 4-8, and/or an ASIC may be configured and/or structured to perform third operation(s)/function(s) corresponding to a third portion of the machine readable instructions represented by the flowcharts of FIGS. 4-8.

It should be understood that some or all of the circuitry of FIGS. 2 and/or 3 may, thus, be instantiated at the same or different times. For example, same and/or different portion(s) of the microprocessor 1100 of FIG. 11 may be programmed to execute portion(s) of machine-readable instructions at the same and/or different times. In some examples, same and/or different portion(s) of the FPGA circuitry 1200 of FIG. 12 may be configured and/or structured to perform operations/functions corresponding to portion(s) of machine-readable instructions at the same and/or different times.

In some examples, some or all of the circuitry of FIGS. 2 and/or 3 may be instantiated, for example, in one or more threads executing concurrently and/or in series. For example, the microprocessor 1100 of FIG. 11 may execute machine readable instructions in one or more threads executing concurrently and/or in series. In some examples, the FPGA circuitry 1200 of FIG. 12 may be configured and/or structured to carry out operations/functions concurrently and/or in series. Moreover, in some examples, some or all of the circuitry of FIGS. 2 and/or 3 may be implemented within one or more virtual machines and/or containers executing on the microprocessor 1100 of FIG. 11.

In some examples, the programmable circuitry 912, 1012 of FIGS. 9 and/or 10 may be in one or more packages. For example, the microprocessor 1100 of FIG. 11 and/or the FPGA circuitry 1200 of FIG. 12 may be in one or more packages. In some examples, an XPU may be implemented by the programmable circuitry 912, 1012 of FIGS. 9 and/or 10, which may be in one or more packages. For example, the XPU may include a CPU (e.g., the microprocessor 1100 of FIG. 11, the CPU 1220 of FIG. 12, etc.) in one package, a DSP (e.g., the DSP 1222 of FIG. 12) in another package, a GPU in yet another package, and an FPGA (e.g., the FPGA circuitry 1200 of FIG. 12) in still yet another package.

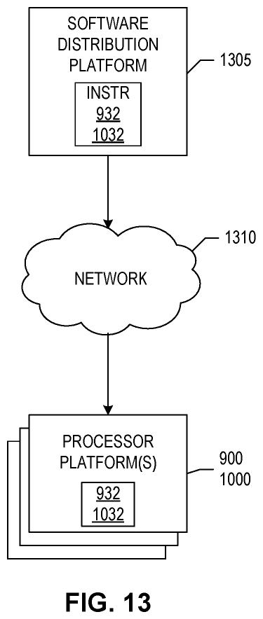

A block diagram illustrating an example software distribution platform 1305 to distribute software such as the example machine readable instructions 932, 1032 of FIGS. 9 and/or 10 to other hardware devices (e.g., hardware devices owned and/or operated by third parties from the owner and/or operator of the software distribution platform) is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 932, 1032 of FIGS. 9 and/or 10. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine readable instructions 932, 1032, which may correspond to the example machine readable instructions of FIGS. 4-8, as described above. The one or more servers of the example software distribution platform 1305 are in communication with an example network 1310, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 932, 1032 from the software distribution platform 1305. For example, the software, which may correspond to the example machine readable instructions of FIG. 4-8, may be downloaded to the example programmable circuitry platform 900, 1000, which is to execute the machine readable instructions 932, 1032 to implement the example client device 110 and/or the example server 120. In some examples, one or more servers of the software distribution platform 1305 periodically offer, transmit, and/or force updates to the software (e.g., the example machine readable instructions 932, 1032 of FIGS. 9 and/or 10) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that provide a remote processing acceleration engine. Disclosed systems, apparatus, articles of manufacture, and methods improve the efficiency of using a computing device by reducing latency in client-to-server communications by identifying and utilizing acceleration hardware and low latency paths for executing an operation. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to a remote processing acceleration engine are disclosed herein. Further examples and combinations thereof include the following:

Example 1 includes an infrastructure processing unit (IPU) comprising an offload engine driver to access a remote procedure call (RPC) from business logic circuitry, network interface circuitry, and RPC offload circuitry to select a destination to perform an operation associated with the RPC call, the destination selected based on an ability of the destination to perform the operation using remote direct memory access (RDMA), and cause communication of the operation to the destination via the network interface circuitry.

Example 2 includes the IPU of example 1, wherein the RPC offload circuitry is to select the destination to perform the operation associated with the RPC call based on a load analysis of a plurality of destinations capable of performing the operation.

Example 3 includes the IPU of example 2, wherein to perform the load analysis, the RPC offload circuitry is to identify the plurality of destinations capable of performing the operation, and determine at least one of a current or a future workload on the destinations.

Example 4 includes the IPU of example 3, wherein to perform the load analysis, the RPC offload circuitry is to eliminate destinations with a heavy current or future workload from the plurality of destinations.

Example 5 includes the IPU of example 4, wherein to perform the load analysis, the RPC offload circuitry is to identify low latency paths for performing the operation based on at least one of the current or the future workload on the plurality of destinations.

Example 6 includes the IPU of example 5, wherein to perform the load analysis, the RPC offload circuitry is to apply a latency threshold to the identified low latency paths, and eliminate destinations from the plurality of destinations that exceed the latency threshold.

Example 7 includes the IPU of example 2, wherein the RPC offload circuitry is to calculate a score for respective ones of the plurality of destinations, the score to weigh which destination is likely to be selected for performing the operation.

Example 8 includes the IPU of example 7, wherein the RPC offload circuitry is to apply a score threshold to the calculated score for the respective ones of the plurality of destinations.

Example 9 includes a non-transitory machine readable storage medium comprising instructions to cause an infrastructure processing unit (IPU) to at least access a remote procedure call (RPC), select a destination to perform an operation associated with the RPC call, the destination selected based on an ability of the destination to perform the operation using remote direct memory access (RDMA), and cause communication of the operation to the destination.

Example 10 includes the non-transitory machine readable storage medium of example 9, wherein the instructions cause the IPU to select the destination to perform the operation associated with the RPC call based on a load analysis of a plurality of destinations capable of performing the operation.

Example 11 includes the non-transitory machine readable storage medium of example 10, wherein the IPU is to identify the plurality of destinations capable of performing the operation, and determine at least one of a current or a future workload on the plurality of destinations.

Example 12 includes the non-transitory machine readable storage medium of example 11, wherein the instructions cause the IPU to eliminate destinations with a heavy current or future workload from the plurality of destinations.

Example 13 includes the non-transitory machine readable storage medium of example 12, wherein the instructions cause the IPU to identify low latency paths for performing the operation based on at least one of the current or the future workload on the plurality of destinations.

Example 14 includes the non-transitory machine readable storage medium of example 13, wherein the instructions cause the IPU to apply a latency threshold to the identified low latency paths, and eliminate destinations from the plurality of destinations that exceed the latency threshold.

Example 15 includes the non-transitory machine readable storage medium of example 10, wherein the instructions cause the IPU to calculate a score for respective ones of the plurality of destinations, the score to weigh which destination is likely to be selected for performing the operation.

Example 16 includes the non-transitory machine readable storage medium of example 15, wherein the instructions cause the IPU to apply a score threshold to the calculated score for the respective ones of the plurality of destinations.

Example 17 includes an apparatus comprising means for accessing a remote procedure call (RPC), means for selecting a destination to perform an operation associated with the RPC call, the destination selected based on an ability of the destination to perform the operation using remote direct memory access (RDMA), and means for causing communication of the operation to the destination.

Example 18 includes the apparatus of example 17, further including means for performing a load analysis on a plurality of destinations capable of performing the operation.

Example 19 includes the apparatus of example 18, wherein the means for selecting is to select the destination to perform the operation associated with the RPC call based on the load analysis.

Example 20 includes the apparatus of example 18, wherein the means for performing is to determine at least one of a current or a future workload on the plurality of destinations, identify low latency paths for performing the operation based on at least one of the current or the future workload on the plurality of destinations, apply a latency threshold to the identified low latency paths, and eliminate destinations from the plurality of destinations that exceed the latency threshold, and calculate a score for respective ones of the plurality of destinations, the score to weigh which destination is likely to be selected for performing the operation.

Example 21 includes a method for an infrastructure processing unit (IPU) to select a destination to perform an operation associated with a remote procedure call (RPC), the method comprising accessing the remote procedure call (RPC), selecting the destination to perform the operation associated with the RPC call, the destination selected based on an ability of the destination to perform the operation using remote direct memory access (RDMA), and causing communication of the operation to the destination.

Example 22 includes the method of example 21, wherein selecting the destination to perform the operation associated with the RPC call is based on a load analysis of a plurality of destinations capable of performing the operation.

Example 23 includes the method of example 22, further including identifying the plurality of destinations capable of performing the operation, and determining at least one of a current or a future workload on the plurality of destinations.

Example 24 includes the method of example 23, further including eliminating destinations with a heavy current or future workload from the plurality of destinations.

Example 25 includes the method of example 24, further including identifying low latency paths for performing the operation based on at least one of the current or the future workload on the plurality of destinations.

Example 26 includes the method of example 25, further including applying a latency threshold to the identified low latency paths, and eliminating destinations from the plurality of destinations that exceed the latency threshold.

Example 27 includes the method of example 26, further including calculating a score for respective ones of the plurality of destinations, the score to weigh which destination is likely to be selected for performing the operation.

Example 28 includes the method of example 27, further including applying a score threshold to the calculated score for the respective ones of the plurality of destinations.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An infrastructure processing unit (IPU) comprising:
an offload engine driver to access a remote procedure call (RPC) from business logic circuitry;
network interface circuitry; and
RPC offload circuitry to:
select a destination to perform an operation associated with the RPC call, the destination selected based on an ability of the destination to perform the operation using remote direct memory access (RDMA); and
cause communication of the operation to the destination via the network interface circuitry.

2. The IPU of claim 1, wherein the RPC offload circuitry is to select the destination to perform the operation associated with the RPC call based on a load analysis of a plurality of destinations capable of performing the operation.

3. The IPU of claim 2, wherein to perform the load analysis, the RPC offload circuitry is to:
identify the plurality of destinations capable of performing the operation; and
determine at least one of a current or a future workload on the destinations.

4. The IPU of claim 3, wherein to perform the load analysis, the RPC offload circuitry is to eliminate destinations with a heavy current or future workload from the plurality of destinations.

5. The IPU of claim 4, wherein to perform the load analysis, the RPC offload circuitry is to identify low latency paths for performing the operation based on at least one of the current or the future workload on the plurality of destinations.

6. The IPU of claim 5, wherein to perform the load analysis, the RPC offload circuitry is to:
apply a latency threshold to the identified low latency paths; and
eliminate destinations from the plurality of destinations that exceed the latency threshold.

7. The IPU of claim 2, wherein the RPC offload circuitry is to calculate a score for respective ones of the plurality of destinations, the score to weigh which destination is likely to be selected for performing the operation.

8. The IPU of claim 7, wherein the RPC offload circuitry is to apply a score threshold to the calculated score for the respective ones of the plurality of destinations.

9. A non-transitory machine readable storage medium comprising instructions to cause an infrastructure processing unit (IPU) to at least:
access a remote procedure call (RPC);
select a destination to perform an operation associated with the RPC call, the destination selected based on an ability of the destination to perform the operation using remote direct memory access (RDMA); and
cause communication of the operation to the destination.

10. The non-transitory machine readable storage medium of claim 9, wherein the instructions cause the IPU to select the destination to perform the operation associated with the RPC call based on a load analysis of a plurality of destinations capable of performing the operation.

11. The non-transitory machine readable storage medium of claim 10, wherein the IPU is to:
identify the plurality of destinations capable of performing the operation; and
determine at least one of a current or a future workload on the plurality of destinations.

12. The non-transitory machine readable storage medium of claim 11, wherein the instructions cause the IPU to eliminate destinations with a heavy current or future workload from the plurality of destinations.

13. The non-transitory machine readable storage medium of claim 12, wherein the instructions cause the IPU to identify low latency paths for performing the operation based on at least one of the current or the future workload on the plurality of destinations.

14. The non-transitory machine readable storage medium of claim 13, wherein the instructions cause the IPU to:
apply a latency threshold to the identified low latency paths; and
eliminate destinations from the plurality of destinations that exceed the latency threshold.

15. The non-transitory machine readable storage medium of claim 10, wherein the instructions cause the IPU to calculate a score for respective ones of the plurality of destinations, the score to weigh which destination is likely to be selected for performing the operation.

16. The non-transitory machine readable storage medium of claim 15, wherein the instructions cause the IPU to apply a score threshold to the calculated score for the respective ones of the plurality of destinations.

17. An apparatus comprising:
means for accessing a remote procedure call (RPC);
means for selecting a destination to perform an operation associated with the RPC call, the destination selected based on an ability of the destination to perform the operation using remote direct memory access (RDMA); and
means for causing communication of the operation to the destination.

18. The apparatus of claim 17, further including means for performing a load analysis on a plurality of destinations capable of performing the operation.

19. The apparatus of claim 18, wherein the means for selecting is to select the destination to perform the operation associated with the RPC call based on the load analysis.

20. The apparatus of claim 18, wherein the means for performing is to:
determine at least one of a current or a future workload on the plurality of destinations;
identify low latency paths for performing the operation based on at least one of the current or the future workload on the plurality of destinations;
apply a latency threshold to the identified low latency paths; and
eliminate destinations from the plurality of destinations that exceed the latency threshold; and
calculate a score for respective ones of the plurality of destinations, the score to weigh which destination is likely to be selected for performing the operation.

21-28. (canceled)
